(19) United States
(12) Patent Application Publication
(10) Pub. No.: US 2026/0313648 A1
(43) Pub. Date: Oct. 8, 2026

(54) UPLINK TRANSMISSION SKIPPING WITH UTO INDICATION

(71) Applicant: Telefonaktiebolaget LM Ericsson (publ), Stockholm (SE)

(72) Inventors: Jonas FRÖBERG OLSSON, Ljungsbro (SE); Bikramjit SINGH, Tenhola (FI); Ying SUN, Täby (SE); Robert KARLSSON, Sundbyberg (SE); Sorour FALAHATI, Stockholm (SE)

(73) Assignee: Telefonaktiebolaget LM Ericsson (publ), Stockholm (SE)

(21) Appl. No.: 19/472,658

(22) PCT Filed: Apr. 8, 2024
(86) PCT No.: PCT/IB2024/053445

§ 371 Date: Oct. 4, 2025

Related U.S. Application Data
(60) Provisional application No. 63/457,870, filed on Apr. 7, 2023.

(51) Int. Cl. H04W 72/21; H04W 28/02; H04W 72/231

(52) U.S. Cl. CPC H04W 72/21; H04W 28/0278; H04W 72/231

(57) ABSTRACT

A method performed by a UE in a wireless communication network according to some embodiments includes receiving a configured grant (CG) configuration in which a plurality of transmission occasions (TOs) are referenced, and transmitting, to a network node in a first TO, an unused TO (UTO) indicator for the CG configuration that indicates that a second TO of the plurality of TOs will be unused. The UE generates uplink control information (UCI) prior to the second TO, and transmits the UCI to the network node in a in a resource other than a resource that is reserved in the second TO.

### RELATED APPLICATIONS

The present application claims priority to and the benefit of U.S. Provisional Patent Application No. 63/457,870, filed on Apr. 7, 2023, which is hereby incorporated by reference in its entirety.

### TECHNICAL FIELD

The present disclosure relates to wireless communication networks, and in particular to wireless communication networks in which wireless communication resources are scheduled using configured grants.

### BACKGROUND

In an ongoing study item on eXtended Reality (XR) in the third generation partnership project (3GPP), several enhancements are being proposed to increase XR capacity of 5G-Advanced systems.

XR includes services provided by computer technologies and wearables that allow for human-machine interaction in real/virtual mixed environments. XR includes Virtual Reality (VR), Augmented Reality (AR), Mixed Reality (MR), Cloud Gaming, and the areas interpolated among them. As such, XR is usually considered a mixed enhanced mobile broadband (eMBB)/ultra-reliable low-latency communication (URLLC) service. As noted in Table 1, XR traffic is a mixture of heterogeneous uplink (UL)/downlink (DL) data flows, including video, audio, and control traffic.

TABLE 1
XR traffic characteristics and requirements identified by 3GPP.

| | | | | Packet |
|---|---|---|---|---|
| | | | Packet | Delay |
| | | Data | (frame) | Budget |
| | | rate | rate | (PDB) |
| | | [Mbps] | [fps] | [ms] |
| DL | AR/VR Video | 30 | 60 | 10 |
| | Cloud Gaming | 30 | 60 | 15 |
| UL | Pose/control | 0.2 | 250 | 10 |
| | Video (Scene) | 10 | 60 | 30 |

Table 1 highlights that XR traffic flows have different characteristics, e.g., packet rate in frames per second and bit rate in bits per second, and requirements in terms of (application) packet delay budget (PDB). Among XR flows, DL video and UL scene traffic are periodic (with possible jitter particularly in DL) and have variable large-sized application packets.

### Configured Grant

The information element (IE) ConfiguredGrantConfig is used to configure uplink transmissions by a user equipment (UE) without a dynamic grant according to two possible schemes. The actual uplink grant may either be configured via radio resource control (RRC) messaging (type1) or provided via the physical downlink control channel (PDCCH) (type2). Multiple Configured Grant (CG) configurations may be configured in one bandwidth part (BWP) of a serving cell.

For both Type 1 and Type 2 configured grant, the UE is provided time-frequency resources on which the UE is allowed to transmit a physical uplink shared channel (PUSCH). The time-frequency resources where UE is allowed to transmit PUSCH are referred to herein as Transmission Occasions (TOs).

For Type 1 configured grant, the time-frequency resources are indicated using timeDomainAllocation, frequencyDomainAllocation and periodicity together with a time reference to the slot in which the TO is located indicated in a RRC message. The periodicity indicates recurrence of the TOs. The timeDomainAllocation indicate first symbol of the PUSCH and the duration of the PUSCH (in symbols) andfrequencyDomainAllocation indicate the Resource Blocks (RBs) used by the PUSCH. For example, timeDomainAllocation may indicate startSymbol=0 and endSymbol=14 (the PUSCH start in the first symbol of the slot and ends in the last symbol) and the time reference may indicate that first TO is in slot 4. If the periodicity is 5 slots, then TOs for the configured grant would be present in the slots 4, 9, 14, 19, 24, . . . . Once the UE has been configured with Type 1 configured grant, the UE may or may transmit a PUSCH on the TOs for the configured grant until UE receives a RRC message disabling the configured grant.

Type 2 configured grant is more flexible than Type 1 configured grant. In a Type 2 configured grant, the UE is provided the periodicity of the configured grant is provided by RRC. The timeDomainAllocation andfrequencyDomainAllocation is provided via PDCCH which simultaneously activates the configured grant. The timeDomainAllocation, together when the activation DCI on PDCCH, is sent to UE and gives the time reference for first TO. The Type 2 configured grant can be deactivated by a deactivation DCI on a PDCCH.

The medium access control (MAC) entity may be configured to skip uplink transmission if the transport block will be empty (or only contain low priority data). In that case, the MAC entity will not generate a MAC protocol data unit (PDU), and the MAC entity will not deliver a grant to the hybrid automatic repeat request (HARQ) entity, and the HARQ entity will not trigger a transmission.

### SUMMARY

A method performed by a UE in a wireless communication network according to some embodiments includes receiving a configured grant (CG) configuration in which a plurality of transmission occasions (TOs) are referenced, and transmitting, to a network node in a first TO, an unused TO (UTO) indicator for the CG configuration that indicates that a second TO of the plurality of TOs will be unused. The UE generates uplink control information (UCI) prior to the second TO, and transmits the UCI to the network node in a in a resource other than a resource that is reserved in the second TO according to the CG configuration.

In some embodiments, the UE does not have a media access control (MAC) protocol data unit, PDU, to transmit during the second TO. In some embodiments, the UE does not have a MAC control element (CE) to transmit during the second TO.

In some embodiments, the UE does not have one of a predetermined list of MAC control elements, CE, to transmit during the second TO. In some embodiments, the predetermined list of MAC CEs includes MAC CEs other than a “periodic buffer status report, BSR, indication no data for any logical channel, LCH” MAC CE or a “padding BSR” MAC CE.

In some embodiments, the UE is configured with a skipping state that indicates whether the UE should skip transmission of uplink data during a TO referenced in the CG configuration.

In some embodiments, when the UE configured with a first parameter, the UE does not transmit a physical uplink shared channel, PUSCH, even if there is UCI data to be multiplexed on the PUSCH. The first parameter may include an enhancedSkipUplinkTxConfigured parameter with value “true”.

The method may further include transmitting a second UTO indicator to the network node indicating that a third TO of the plurality of TOs is “not unused”, and transmitting a physical uplink shared channel (PUSCH) including UCI other than a UTO indicator during the third TO.

A method performed by a UE according to further embodiments includes receiving a CG configuration in which a plurality of TOs are referenced, transmitting, to a network node in a first TO of the plurality of TOs, a UTO indicator for the CG configuration that indicates that a second TO of the plurality of TOs will be unused, generating UCI prior to the second TO, and transmitting the UCI in the second TO.

A method performed by a network node in a wireless communication network according to some embodiments includes configuring a UE with a CG configuration in which a plurality of TOs are referenced. The network node receives, from the UE in a first TO, a UTO indicator for the CG configuration that indicates that a second TO will be unused, even though the UE has UCI to be transmitted in the second TO, and receives the UCI from the UE in a resource other than the second TO.

In some embodiments, the UE does not have a media access control (MAC) protocol data unit, PDU, to transmit during the second TO. In some embodiments, the UE does not have a MAC control element (CE) to transmit during the second TO.

In some embodiments, the UE does not have one of a predetermined list of MAC control elements, CE, to transmit during the second TO. In some embodiments, the predetermined list of MAC CEs includes MAC CEs other than a “periodic buffer status report, BSR, indication no data for any logical channel, LCH” MAC CE or a “padding BSR” MAC CE.

In some embodiments, the UE is configured with a skipping state that indicates whether the UE should skip transmission of uplink data during a TO referenced in the CG configuration.

In some embodiments, when the UE configured with a first parameter, the UE does not transmit a physical uplink shared channel, PUSCH, even if there is UCI data to be multiplexed on the PUSCH. The first parameter may include an enhancedSkipUplinkTxConfigured parameter with value “true”.

A method performed by a network node according to further embodiments includes configuring a UE with a CG configuration in which a plurality of TOs are referenced, receiving, from the UE in a first TO, a UTO indicator for the CG configuration that indicates that a second TO will be unused, and receiving the UCI from the UE in the second TO.

### BRIEF DESCRIPTION OF THE DRAWINGS

FIG. 1 illustrates serving XR traffic using CG on a TDD carrier with a DDDUU pattern and 30 kHz sub-carrier spacing (SCS).

FIG. 2 illustrates an example of uplink transmission skipping with UTO indication according to some embodiments.

FIG. 3 illustrates a method performed by a UE in a wireless communication network according to some embodiments.

FIG. 4 illustrates a method performed by a network node in a wireless communication network according to some embodiments.

FIG. 5 illustrates an example of uplink transmission skipping with UTO indication according to some embodiments.

FIG. 6 illustrates a method performed by a UE in a wireless communication network according to some embodiments.

FIG. 7 illustrates a method performed by a network node in a wireless communication network according to some embodiments.

FIG. 8 shows an example of a communication system in accordance with some embodiments.

FIG. 9 shows a UE in accordance with some embodiments.

FIG. 10 shows a network node in accordance with some embodiments.

### DETAILED DESCRIPTION OF EMBODIMENTS

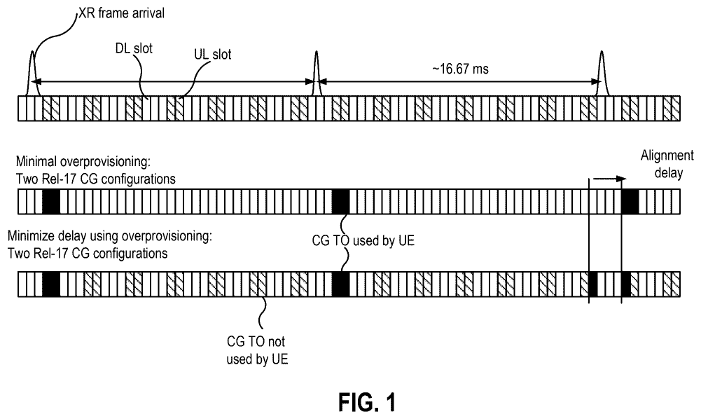

A problem with using configured grants is that XR frame rates result in non-integer periodicity, e.g., 60 frames/second≈16.67 ms, which makes it difficult or impossible to perfectly align CG TOs with the arrival of an XR frame. This becomes especially difficult on time division duplex (TDD) carriers. When utilizing CG to serve XR traffic, the gNodeB (gNB) base station often needs to overprovision CG resources to meet the latency requirements. This may result in inefficient resource utilization due to overprovisioning of configured grant resources as illustrated in FIG. 1, which illustrates serving XR traffic using CG on a TDD carrier with a DDDUU pattern and 30 kHz sub-carrier spacing (SCS).

In the XR Work Item Description for Rel-18, it has been agreed to include an objective to solve the over provisioning problem and improve XR capacity, when CG is used to serve XR traffic by enabling the UE to dynamically indicate unused CG PUSCH occasion(s) based on uplink control information (UCI) to the gNB. In particular it has been agreed to specify enhancements related to capacity, including dynamic indication of unused CG PUSCH occasion(s) based on UCI by the UE.

It was further agreed to specify enhancements related to multiple CG PUSCH transmission occasions in a period of a single CG PUSCH configuration, buffer status report (BSR) enhancements including at least new buffer status (BS) Table(s), delay reporting of buffered data in uplink, provision of XR traffic assistance information for DL and UL (e.g. periodicity), and discard operation of PDU Sets.

As part of the feature design, methods to determine the content of the UCI such that it can serve the intended purpose, are needed.

At RAN1 #112 meeting the agreements shown in Table 2 were made.

TABLE 2
RAN1#112 Agreements

Agreement
The physical channel that carries the UCI that provides information about unused CG PUSCH
transmission occasions is CG PUSCH.
Agreement
Encoding and multiplexing for “the UCI that provides information about unused CG PUSCH
transmission occasions” in a CG PUSCH applies encoding and multiplexing procedures for
CG-UCI as baseline.

| | |
|---|---|
| • | FFS on details |

Agreement
Consider the following alternatives for “the UCI that provides information about unused CG
PUSCH transmission occasions” for down-selection or revision

| | |
|---|---|
| • | Alt. 1: “The UCI that provides information about unused CG PUSCH transmission |

occasions” is defined as a new UCI.

| | |
|---|---|
| ∘ | FFS on details |

| | |
|---|---|
| • | Alt. 2: “The UCI that provides information about unused CG PUSCH transmission |
| | occasions” is added as new field(s) to the CG-UCI. |

| | |
|---|---|
| ∘ | FFS on details |

| | |
|---|---|
| • | Alt. 3: “The UCI that provides information about unused CG PUSCH transmission |
| | occasions” replaces/re-purposes some field(s) of the CG-UCI. |

| | |
|---|---|
| ∘ | FFS on details |

Agreement
For dynamic indication of unused CG PUSCH occasion(s) based on a UCI, the following options
for further down-scoping with possible revision, are considered for the transmission occasion of
the UCI:

| | |
|---|---|
| • | Option 1: A transmitted CG PUSCH, includes the UCI. |

| | |
|---|---|
| ∘ | FFS details |

| | |
|---|---|
| • | Option 2: A transmitted CG PUSCH includes the UCI, if it is transmitted in an occasion |
| | determined by RRC. |

| | |
|---|---|
| ∘ | FFS details |

| | |
|---|---|
| • | Option 3: A transmitted CG PUSCH includes the UCI, if it is transmitted in a pre-defined |
| | transmission occasion. |

| | |
|---|---|
| ∘ | FFS details |

| | |
|---|---|
| ▪ | Example of a pre-determined occasion: 1^{st} configured PUSCH TO in a CG |

period or 1^{st} configured PUSCH TO in a multiple CG periods

| | |
|---|---|
| • | Option 4: A transmitted CG PUSCH includes the UCI, if it is transmitted in a transmission |
| | occasion determined satisfying given condition(s). |

| | |
|---|---|
| ∘ | FFS details |

| | |
|---|---|
| ▪ | Examples of a condition: A first transmitted PUSCH in a CG period, or a |

first PUSCH transmission within a multiple of CG periods.

Other options are not precluded. Proponent companies to provide details.
Agreement
For dynamic indication of unused CG PUSCH transmission occasion(s) based on a UCI, the
following options for further down-scoping, are considered for the information provided by the
UCI:

| | |
|---|---|
| • | Option 1: The UCI determines the consecutive CG PUSCH TO(s) that are indicated as |
| | “unused” |

| | |
|---|---|
| ∘ | Option 1-1: The UCI provides the number of consecutive TO(s) in time domain. |

| ▪ | Applicable numbers can be determined from information obtained from |
|---|---|
| | configuration. |
| ▪ | FFS details |

| | |
|---|---|
| ∘ | Option 1-2: The UCI provides a time duration/range that includes the consecutive |

TO(s) in time domain.

| ▪ | Applicable time duration/range can be determined from information |
|---|---|
| | obtained from configuration |
| ▪ | FFS details |

| | |
|---|---|
| • | Option 2: The UCI determines the CG PUSCH TO(s) that are indicated as “unused” |
| | (consecutive/non-consecutive TO(s) in time domain) |

| | |
|---|---|
| ∘ | Option 2-1: The UCI provides a bitmap where a bit corresponds to a TO within a |

time duration/range. The bit indicates whether the TO is “unused”.

| ▪ | Applicable time duration/range can be determined from information |
|---|---|
| | obtained from configuration |
| ▪ | FFS details |

| | |
|---|---|
| ∘ | Option 2-2: The UCI provides a bitmap where a bit corresponds to TOs within a |

time duration/range. The bit indicates whether all TOs within the time
duration/range are “unused”.

| ▪ | Applicable time duration/range can be determined from information |
|---|---|
| | obtained from configuration |
| ▪ | FFS details |

| | |
|---|---|
| • | FFS whether/how the unused TO(s) can be associated to multiple CG configuration. |
| • | Other options are not precluded. Proponent companies to provide details. |

Certain aspects of the disclosure and their embodiments may provide solutions to these or other challenges. In particular, some embodiments provide methods for uplink skipping in combination with a configured grant Unused Transmission Occasion (UTO) indication.

Certain embodiments may provide one or more technical advantages. In particular, some embodiments described herein may enable reduced hypothesis testing in a gNB.

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

In the embodiments described herein, functionality is applied based on indicating ‘un-used’ TOs using radio resource control (RRC), physical (PHY), and other higher layer configurations. However, the same embodiments can be utilized to indicate ‘used’ TOs, instead of un-used TOs. For instance, if a UCI indicating subset of un-used TOs (in below embodiments), the concept in the embodiments can be used to reinterpret or repurpose the functionality to indicate ‘used’ TOs from the group/plurality of TOs, because: ‘used TOs set’=‘plurality/group of TOs set’ MINUS ‘un-used TOs set’.

Embodiments described herein may be combined to longer periods of used and unused TOs. For example, the UE may indicate some TOs as unused, some other TOs as used and then some TOs as unused (in a detailed example with three consecutive time periods T1, T2 and T3, the UE may indicate the TOs in T1 and T3 as unused, while the TOs in T2 as used, or vice versa the UE may indicate that the TOs in T1 and T3 are used while the TOs in T2 are unused).

In some embodiments, “configured uplink grant transmission”, “CG TOs”, “PUSCH duration of configured grant”, “configured grant PUSCH”, “PUSCH is correspond to a configured grant,” etc., are various ways to express reference a transmission occasion where UE may transmit a PUSCH associated/assigned by a configured grant. Furthermore, in MAC specification a configured grant is considered to “reoccur” or “sequentially occur.”

The terms “reoccurring” and “sequentially occurring” are sometimes viewed as that there are multiple TOs associated with a configured grant and sometimes viewed as that a reoccurring or sequentially occurring uplink (configured) grant.

In some embodiments, alternative to the embodiments below, a ‘slot’ may be a sub-slot or “transmission unit”.

The term TO can be synonymous to configured PUSCH, or transport block (TB) resource.

A UE may be configured with multiple CG configurations. The CG configurations may be associated to the same or different cells/carriers, or to the same or different bandwidth part (BWP) associated to the same or different cells/carriers. In some embodiments described below, when multiple CG configurations are referred to different carriers, the methods are applicable even if the multiple CG configurations are associated to the same or different cells/carriers, or to the same or different BWP associated to the same or different cells/carriers, unless explicitly stated.

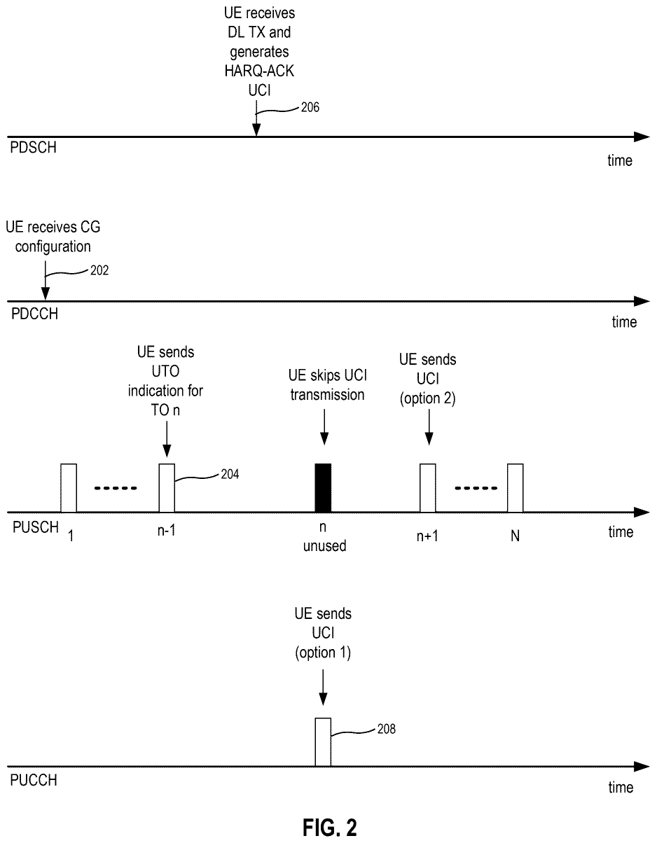

FIG. 2 illustrates an example of uplink transmission skipping with UTO indication according to some embodiments. In particular, FIG. 2 is a timeline that illustrates receptions by a UE on the physical downlink control channel (PDCCH) and the physical downlink shared channel (PDSCH), and transmissions on the physical uplink control channel (PUCCH) and the physical uplink shared channel (PUSCH).

Referring to FIG. 2, a UE receives a CG configuration 202 via transmission from the network on the PDCCH. The CG configures the UE for transmission of PUSCH at a plurality of predefined TOs 1 . . . N. At some point, the UE determines that TO n will be unused, and sends, in TO n−1, a UTO 204 indicating that TO n will be unused by the UE. Subsequently, but before TO n, the UE receives a PDSCH transmission 206 from the network. The UE generates HARQ-ACK UCI based on the PDSCH transmission 206. Ordinarily, the UE would transmit the UCI at TO n. However, because the UE transmitted a UTO indicating that TO n would be unused, the UE skips transmission on TO n and instead transmits the UCI on a resource other than TO n. For example, in some embodiments, the UE may transmit the UCI in PUCCH transmission 208. The resources used for the PUCCH transmission 208 may fully or partially overlap in time with TO n.

In other embodiments, the UE may transmit the UCI in a subsequent TO, such as TO n+1.

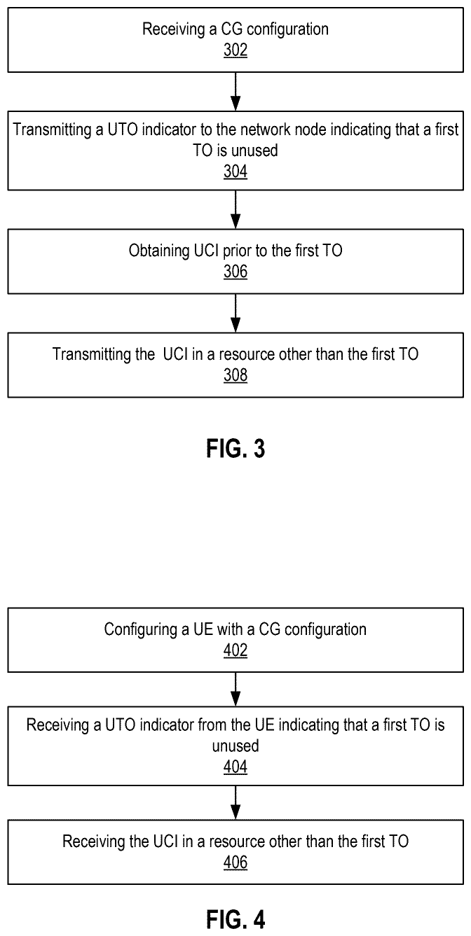

FIG. 3 illustrates a method performed by a UE in a wireless communication network. The method includes receiving a configured grant configuration in which a plurality of TOs are configured on the PUSCH (block 302). The UE transmits, to a network node, a UTO indicator for the CG configuration that indicates that the first TO will be unused (block 304). Prior to the first TO, the UE obtains UCI to be transmitted to the network (block 306). Ordinarily, the UCI would be transmitted to the network in the first TO. However, because the first TO was indicated by the UE in the UTO indicator as being unused, the UE transmits the UCI on a resource other than the first TO (block 308).

FIG. 4 illustrates a method performed by a network node in a wireless communication network. The method includes configuring a UE with a CG configuration in which a plurality of PUSCH TOs are configured (block 402). The network node receives from the UE a UTO indicator for the CG configuration that indicates that a first TO will be unused (block 404). The network node then receives UCI from the UE that would otherwise be transmitted in the first TO, on a resource other than the first TO (block 406).

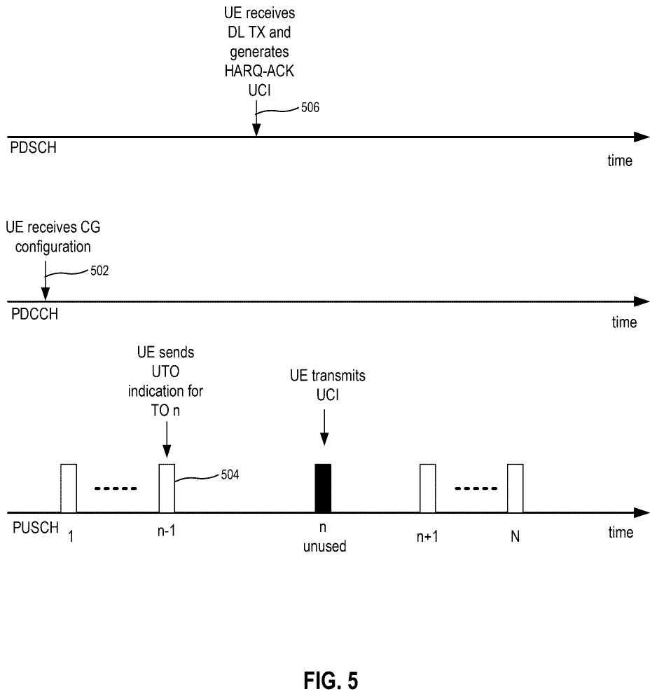

In some embodiments, the UE may transmit UCI in a TO even if the UE had previously indicated that the TO would be unused. For example, referring to FIG. 5, a UE receives a CG configuration 502 via transmission from the network on the PDCCH. The CG configures the UE for transmission of PUSCH at a plurality of predefined TOs 1 . . . N. At some point, the UE determines that TO n will be unused, and sends, in TO n−1, a UTO 504 indicating that TO n will be unused by the UE. Subsequently, but before TO n, the UE receives a PDSCH transmission 506 from the network. The UE generates HARQ-ACK UCI based on the PDSCH transmission 506. Even though the UE transmitted a UTO indicating that TO n would be unused, the UE transmits the UCI in TO n.

In other embodiments, the UE may transmit the UCI in a subsequent TO, such as TO n+1.

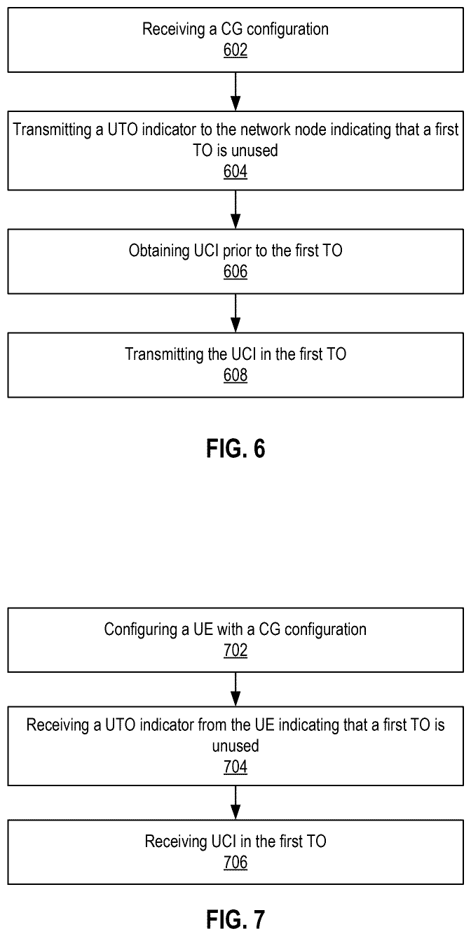

FIG. 6 illustrates a method performed by a UE in a wireless communication network. The method includes receiving a configured grant configuration in which a plurality of TOs are configured on the PUSCH (block 602). The UE transmits, to a network node, a UTO indicator for the CG configuration that indicates that the first TO will be unused (block 604). Prior to the first TO, the UE obtains UCI to be transmitted to the network (block 606). Even though the first TO was indicated by the UE in the UTO indicator as being unused, the UE transmits the UCI in the first TO (block 608).

FIG. 7 illustrates a method performed by a network node in a wireless communication network. The method includes configuring a UE with a CG configuration in which a plurality of PUSCH TOs are configured (block 702). The network node receives from the UE a UTO indicator for the CG configuration that indicates that a first TO will be unused (block 704). The network node then receives UCI from the UE in the first TO, notwithstanding the UTO indicating that the first TO would be unused.

Various example implementations of the above embodiments will now be described in more detail.

In some embodiments, the UE is configured with a CG with multiple TOs, where the UE may transmit a PUSCH on each TO. TOs are referenced herein as TO₁, TO₂, . . . To each of the TOs there are time instances t₁, t₂, . . . corresponding the start time of the TO. At a time T₁ the UE transmitted a first UTO (Unused TO) indicator indicating a sub-set S₁={TOᵢ_{₁}, TOᵢ_{₂}, . . . , TOᵢ_{_{I} of the TOs to be “unused”, where a TO indicated as “unused” is understood as an indication from the UE that it will not perform a PUSCH on the TO. At a later time T}}₂>T₁ the UE transmits a second UTO (Unused TO) indicator indicating a sub-set S₂={TOⱼ_{₁}, TOⱼ_{₂}, . . . , TOⱼ_{_{J} of the TOs to be “unused”. A set S of TOs may also be defined in terms of time periods, that is, S may be a period from time t}}₁ to time t₂ and each TO that occur in this time period belongs to the set S, then the TOs in set S may be indicated to be used or unused.

In some embodiments, a UE is configured with the parameter enhancedSkipUplinkTxConfigured-r16 (value “true”) wherein if a TOₖ is indicated as “unused” by the UE, the UE does not transmit a PUSCH on TOₖ even if there is UCI to be multiplexed on the PUSCH. In some embodiments, the UE transmits the UTO indicating “not unused” only if UE builds a MAC PDU including at least on MAC SDU (i.e., no padding data) while in other embodiments the UE may transmit the UTO indicator indicating “not unused” if UE builds a MAC PDU including at least one MAC service data unit (SDU) or MAC control element (CE). In some examples, the UE may be allowed to indicate “not unused” if MAC PDU includes zero MAC SDUs only if at least one MAC CE from a subset of MAC CEs is included in the MAC PDU. In further other embodiments, the UE may be configured two or more skipping-states, such as:
state0: Only skip TOs indicated as “unused”
state1: TOs indicated as “not unused” may be skipped if UE would build zero MAC PDUs and no MAC CEs other than “periodic BSR indication no data for any logical channel (LCH)” or “padding BSR”
   wherein the UE is indicated by a MAC CE which state to use. Several other example states are possible and are not excluded. In another example the UE may be configured to include a flag for the skipping state in the UCI when indicating UTOs, where the flag may indicate the state2 (the UE will skip all TOs indicated as unused) or state3 (the UE may or may not use the TOs indicated as unused). That is, the UE itself selects whether it shall be allowed to use a TO at a later stage or not and the informs the gNB. Alternatively, the UE may indicate the skipping state in the UCI when indicating UTOs separately for each TO, that is one flag per future TO.

In some embodiments, the UE is configured with the parameter enhancedSkipUplinkTxConfigured-r16 (value “true”) wherein if a TOₖ is indicated as “unused” by the UE, the UE transmits a PUSCH on TOₖ if there is UCI to be multiplexed on the PUSCH. In other words, the indication is not applicable and is ignored in case of a CG-PUSCH multiplexed by UCI.

In some embodiments, the UE is configured to transmit a UTO indicator for a set of CG configurations and further configured with “onlySkipUnused” for a sub-set of the set of CG configurations. In such embodiments, if UE indicates “not unused” for a TO that belongs to a CG configuration in said sub-set of the set of CG configurations the UE always transmit a CG PUSCH unless UE is prevented from doing so, e.g., by a dynamic PUSCH overriding said CG PUSCH or indicated as “unused”. The UE may be configured with “onlySkipUnused” by RRC, MAC CE or DCI. For example, “onlySkipUnused” could be activated/deactivated by a MAC CE.

In some embodiments, the UE is configured with the parameter skipUplinkTxDynamic and is configured to transmit a UTO indicator for a set of CG configurations and further configured with “onlySkipUnused” for a sub-set of the set of CG configurations. In such embodiments, if the UE indicates “not unused” for a TO that belongs to a CG configuration in the sub-set of the set of CG configurations, the UE always transmits a CG PUSCH unless the UE is prevented from doing so, e.g., by a dynamic PUSCH overriding the CG PUSCH or indicated as “unused”. The UE may be configured with “onlySkipUnused” by RRC, MAC CE or DCI. For example, “onlySkipUnused” could be activated/deactivated by a MAC CE.

In some embodiments, the UE is configured with the parameter skipUplinkTxDynamic and is configured to transmit a UTO indicator for a set of CG configurations and further configured with “onlySkipUnused” for a sub-set of the set of CG configurations. In such embodiments, if there is UCI to be multiplexed on a CG PUSCH or if the UE indicates “not unused” for a CG PUSCH TO that belongs to a CG configuration in said sub-set of the set of CG configurations, the UE always transmits the CG PUSCH unless it is prevented from doing so, e.g., by a dynamic PUSCH overriding said CG PUSCH or indicated as “unused”. The UE may be configured with “onlySkipUnused” by RRC, MAC CE or DCI. For example, “onlySkipUnused” could be activated/deactivated by a MAC CE.

In some embodiments, the UE is configured with the parameter skipUplinkTxDynamic and is configured to transmit a UTO indicator for a set of CG configurations and is further configured with “onlySkipUnused” for a sub-set of the set of CG configurations. In such embodiments, if there is UCI to be multiplexed on a CG PUSCH (irrespective of being indicated as “unused2 or “not unused”) or if the UE indicates “not unused” for a CG PUSCH TO that belongs to a CG configuration in said sub-set of the set of CG configurations, the UE always transmits the CG PUSCH unless it is prevented from doing so, e.g., by a dynamic PUSCH overriding the CG PUSCH or indicated as “unused”. The UE may be configured with “onlySkipUnused” by RRC, MAC CE or DCI. For example, “onlySkipUnused” could be activated/deactivated by a MAC CE.

In some embodiments, the UE is configured with PUSCH repetitions with a REPETITION_NUMBER number of repetitions and configured with the parameter enhancedSkipUplinkTxConfigured-r16 (value “true”), wherein if the UE transmitted a UTO indicator indicating “not unused” for REPETITION_NUMBER >1 consecutive TOs then the UE transmits REPETITION_NUMBER PUSCH repetitions on the consecutive TOs. In some such embodiments, if the UE builds a MAC PDU including at least one MAC SDU, the UE indicates “not unused” for the consecutive TOs. Otherwise, the UE indicates “unused.”

In other such embodiments, if the UE builds a MAC PDU including at least one MAC SDU or MAC CE, the UE indicates “not unused” for the consecutive TOs, and otherwise the UE indicates “unused”. In a further embodiments, if the UE builds a MAC PDU including at least one MAC SDU or MAC CE, or there is UCI to be multiplexed on the first TO of the consecutive TOs, the UE indicates “not unused” or “may be used”. Otherwise, the UE indicates “unused”.

The previous embodiment with enhancedSkipUplinkTxConfigured-r16 and repetitions different skipping states may be configured to the UE. The skipping-state used by the UE may be controlled via MAC CE signaling.

In the above embodiments, the UTO indicator is binary indicator of a referenced TO. In such embodiments, “unused” is a definite statement that the UE will not transmit a CG PUSCH on the referenced TO, while “not unused” means that UE will definitely “use” the TO or “may be using” the TO. If the UTO indicator would be three-valued “used”, “may be used” or “unused,” then in the above embodiment, the indication “not unused” could be replaced by “may be used”.

In some of the foregoing embodiments, the MAC CE in “at least one MAC SDU or MAC CE” may be one MAC CE other than a “periodic BSR indicating no data for any LCG” or a “padding BSR”.

In some of the foregoing embodiments, the UE may be configured with PUSCH repetitions with REPETITION_NUMBER either from the parameter numberOfRepetitions being present in the resource allocation table or from the RRC parameter pusch-AggregationFactor.

In some embodiments, the PUSCH repetitions applied the UTO indicator reference a group or set of consecutive TOs, where the TOs in the group/set are associated with all repetitions of the PUSCH. For example, if PUSCH #1_rep1, PUSCH #rep2, PUSCH #1_rep1, PUSCH #rep2 would be transmitted on TOs TO #n, TO #n+1, TO #n+2, TO #n+3, then one bit in a bitmap UTO indicator would reference {TO #n, TO #n+1} and another bit would reference {TO #n+2, TO #n+3}.

In some embodiments, if the UE would multiplex UCI other than a UTO-indicator on a PUSCH on TOₖ referenced by a UTO indicator, then the UE transmits a PUSCH on TOₖ if TOₖ is indicated as “not unused” and does not transmit a PUSCH on TOₖ if TOₖ

In some embodiments, the UTO indication is sent for TOs of one serving cell (or for one BWP), and one or more UTO indication is sent for the TOs in other serving cell (other BWP) that are not the same as the first serving cell (first BWP).

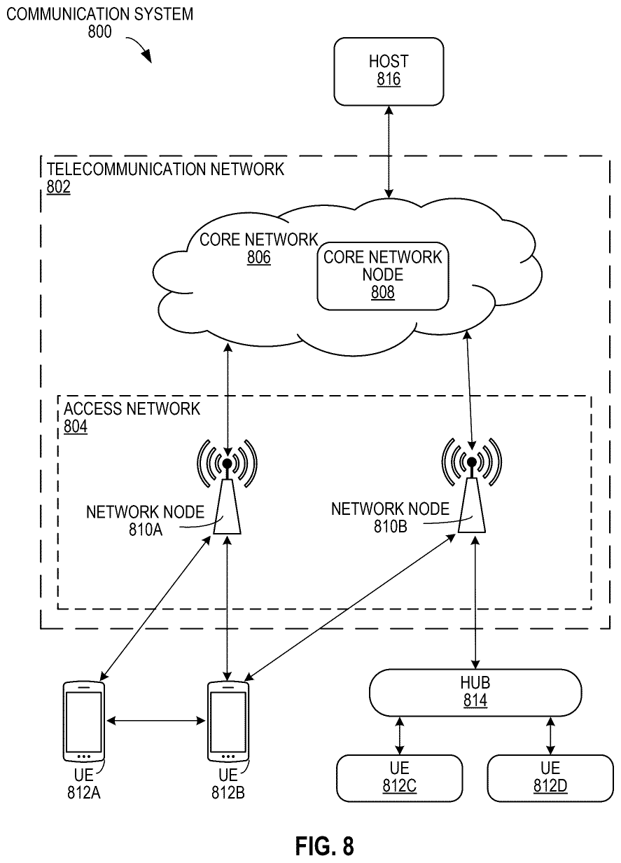

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

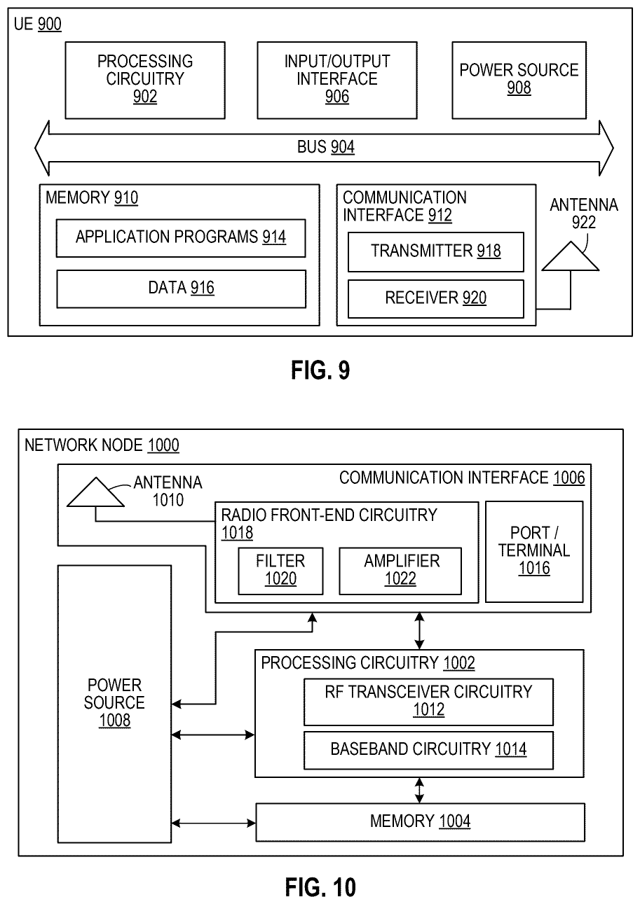

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE, in a wireless communication network, comprising:
receiving a configured grant, CG, configuration, wherein a plurality of transmission occasions, TOs, are referenced in the CG configuration;
transmitting, to a network node in a first TO of the plurality of TOs, an unused TO, UTO, indicator for the CG configuration that indicates that a second TO of the plurality of TOs will be unused;
generating uplink control information, UCI, prior to the second TO; and
transmitting the UCI in a resource other than a resource that is reserved in the second TO according to the CG configuration.

2. The method of claim 1, wherein the UE does not have a media access control, MAC, protocol data unit, PDU, to transmit during the second TO, and/or the UE does not have a MAC control element, CE, to transmit during the second TO.

3. (canceled)

4. The method of claim 1, wherein the UE does not have one of a predetermined list of MAC control elements, CE, to transmit during the second TO.

5. The method of claim 4, wherein the predetermined list of MAC CEs comprises MAC CEs other than a “periodic buffer status report, BSR, indication no data for any logical channel, LCH” MAC CE or a “padding BSR” MAC CE.

6. The method of claim 1, wherein the UE is configured with a skipping state that indicates whether the UE should skip transmission of uplink data during a TO referenced in the CG configuration.

7. The method of claim 1, wherein when the UE configured with a first parameter, the UE does not transmit a physical uplink shared channel, PUSCH, during the second TO even if there is UCI data to be multiplexed on the PUSCH.

8. The method of claim 7, wherein the first parameter comprises an enhancedSkipUplinkTxConfigured parameter with value “true”.

9. The method of claim 1, further comprising transmitting a second UTO indicator to the network node indicating that a third TO of the plurality of TOs is “not unused”, and
transmitting a physical uplink shared channel, PUSCH, including UCI other than a UTO indicator during the third TO.

10. The method of claim 1, wherein the UCI is transmitted in a physical uplink control channel, PUCCH, transmission that at least partially overlaps in time with the second TO.

11. The method of claim 1, wherein the UCI is transmitted in a physical uplink shared channel, PUSCH, transmission that does not use a resource that is reserved in the second TO according to the CG configuration.

12. A method performed by a user equipment, UE, in a wireless communication network, comprising:
receiving a configured grant, CG, configuration, wherein a plurality of transmission occasions, TOs, are referenced in the CG configuration;
transmitting, to a network node in a first TO of the plurality of TOs, an unused TO, UTO, indicator for the CG configuration that indicates that a second TO of the plurality of TOs will be unused;
generating uplink control information, UCI, prior to the second TO; and
transmitting the UCI in the second TO.

13. The method of claim 12, wherein when the UE configured with a first parameter, the UE does not transmit a physical uplink shared channel, PUSCH, even if there is UCI data to be multiplexed on the PUSCH.

14. The method of claim 13, wherein the first parameter comprises an enhancedSkipUplinkTxConfigured parameter with value “true”.

15. The method of claim 12, further comprising transmitting a second UTO indicator to the network node indicating that a third TO of the plurality of TOs is “not unused”, and
transmitting a physical uplink shared channel, PUSCH, including UCI other than a UTO indicator during the third TO.

16. A method performed by a network node in a wireless communication network, comprising:
configuring a user equipment, UE, with a configured grant, CG, configuration, wherein a plurality of transmission occasions, TOs, are referenced in the CG configuration; and
receiving, from the UE in a first TO, an unused TO, UTO, indicator for the CG configuration that indicates that a second TO will be unused, even though the UE has uplink control information, UCI, to be transmitted in the second TO; and
receiving the UCI from the UE in a resource other than the second TO.

17. The method of claim 16, wherein the UE does not have a media access control, MAC, protocol data unit, PDU, to transmit during the first TO; and/or the UE does not have a MAC control element, CE, to transmit during the first TO.

18. (canceled)

19. The method of claim 16, wherein the UE does not have one of a predetermined list of MAC control elements, CE, to transmit during the first TO.

20. The method of claim 19, wherein the predetermined list of MAC CEs comprises MAC CEs other than a “periodic buffer status report, BSR, indication no data for any logical channel, LCH” MAC CE or a “padding BSR” MAC CE.

21-22. (canceled)

23. A method performed by a network node in a wireless communication network, comprising:
configuring a user equipment, UE, with a configured grant, CG, configuration, wherein a plurality of transmission occasions, TOs, are referenced in the CG configuration; and
receiving, from the UE in a first TO, an unused TO, UTO, indicator for the CG configuration that indicates that a second TO will be unused; and
receiving the UCI from the UE in the second TO.
